(19) United States
(12) Patent Application Publication
(10) Pub. No.: US 2019/0387344 A1
(43) Pub. Date: Dec. 19, 2019

(54) SURROUND AUDIO DEVICE AND METHOD OF PROVIDING MULTI-CHANNEL SURROUND AUDIO SIGNAL TO A PLURALITY OF ELECTRONIC DEVICES INCLUDING A SPEAKER

(71) Applicant: LG Electronics Inc., Seoul (KR)

(72) Inventors: Ye Jin KIM, Seoul (KR); Byeong Ha KIM, Incheon (KR); Ye Kyung KIM, Gyeonggi-do (KR)

(21) Appl. No.: 16/551,990

(22) Filed: Aug. 27, 2019

(30) Foreign Application Priority Data
Jul. 15, 2019 (KR) 10-2019-0085387

(51) Int. Cl. H04S 7/00; H04R 3/12; H04R 5/02; H04R 5/04; H04S 3/00

(52) U.S. Cl. CPC H04S 7/301; H04R 3/12; H04R 5/02; H04S 2400/13; H04S 3/008; H04S 2400/01; H04S 2400/15; H04R 5/04

(57) ABSTRACT

A multi-channel surround audio signal providing method is performed by one or more of an audio device and a mobile terminal in electronic devices including speakers capable of receiving an audio signal in a 5G environment connected for Internet of Things. The method includes searching for electronic devices capable of receiving a multi-channel surround audio signal, designating two or more of the electronic devices as a surround speaker sound channel, transmitting a test audio signal generated to synchronize a level of the sound of the surround speaker sound channel to the electronic devices, receiving a signal of the output feedback audio from a microphone, and adjusting a level of an audio output by the electronic devices, based on the feedback audio signal to synchronize the level of the sound of the surround speaker sound channel. The method operates between an audio device and a wireless speaker by 5G communication.

### CROSS-REFERENCE TO RELATED APPLICATION

This present application claims benefit of priority to Korean Patent Application No. 10-2019-0085387, entitled “SURROUND AUDIO DEVICE AND METHOD OF PROVIDING MULTI-CHANNEL SURROUND AUDIO SIGNAL TO A PLURALITY OF ELECTRONIC DEVICES INCLUDING A SPEAKER” and filed on Jul. 15, 2019, in the Korean Intellectual Property Office, the entire disclosure of which is incorporated herein by reference.

### BACKGROUND

### 1. Technical Field

The present disclosure relates to an audio device, an audio system, and a method which provide an audio signal to speakers of a plurality of electronic devices which is capable of receiving an audio signal, and more particularly, to an audio device, a system, and a method which are capable of constructing a multi-channel audio system with a reduced cost using electronic devices which can be connected to each other by Bluetooth, 5G, or internet of things (IoT) and maintaining output synchronization between a plurality of speakers.

### 2. Description of the Related Art

In accordance with the development of image and sound processing technologies, high definition and high quality sound contents are massively produced. Content consumers who demand high definition and high quality sound contents want realistic images and sounds and thus demands for stereoscopic images and stereophonic sounds are increasing.

In order to implement stereophonic sounds, a plurality of speakers is disposed in different locations of a listening space so that respective speakers output same or different sound signals. Therefore, a listener may feel a sense of space.

In a TV system or an audio system which implements stereophonic sounds, a high performance audio device which is capable of processing a multi-channel audio signal and a plurality of speakers which outputs the multi-channel audio need to be additionally provided so that a high cost is required to implement the system.

Further, in order to precisely implement the stereophonic sound in a listening position by harmonizing sounds output by the plurality of speakers, professional installation techniques are required and thus additional cost and efforts are required to install the equipment.

With regard to this, according to the related art, an example of a surround audio device discloses a technique of an algorithm and a system which simulate a 5.1 channel surround sound effect with two speakers using a sound field effect.

However, even though the sound field effect is used, it is difficult to provide a realistic stereophonic sound with only two speakers so that speakers may be required as many as the number of channels for a realistic stereophonic sound effect.

In the meantime, in the stereophonic sound system, generally, a plurality of speakers is connected to each other through a wire so that a cable layout connected between the audio device and the speaker becomes complicated and the connected speakers are used exclusively for the stereophonic sound system. Further, once the speakers are installed, it is very difficult to rearrange the speakers.

With regard to this, according to the related art, another example of the surround audio device provides a technology in which a main speaker and a sub speaker are attachable/detachable and communicate with each other through a wire or wirelessly. Further, whether the speakers are attached or detached is automatically detected to output an audio signal in different modes and bi-directional communication with an external mobile device is allowed.

However, the related art does not disclose a method for implementing a stereophonic sound using a plurality of wired/wireless speakers and additional studies are required to provide a stereophonic sound effect with combination of wired/wireless speakers.

In spite of various attempts of the related art, there is a demand for a technology for an audio device which is capable of providing a realistic stereophonic sound effect while constructing a multi-channel audio system at a low cost.

### SUMMARY OF THE INVENTION

An object to be achieved by the present disclosure is to provide an audio device, an audio system, and a method which are capable of receiving an existing audio signal or wirelessly implementing a stereophonic sound system using speakers of electronic devices embedded with artificial intelligence (AI), thereby solving the problems in that a plurality of speakers needs to be additionally provided as many as the number of channels to implement a stereophonic sound by providing a multi-channel audio signal to speakers of the plurality of electronic devices and thus an additional cost is required.

Another object to be achieved by the present disclosure is to provide an audio device, an audio system, and a method which are capable of implementing a surround sound system which senses the movement of electronic devices since when the surround audio sound is configured by the speakers of the plurality of electronic devices, the electronic devices may move for their original functions.

Another object to be achieved by the present disclosure is to provide an audio device, an audio system, and a method which implement a stereophonic sound system by combining a wired speaker and a wireless speaker, thereby solving the problem in that speakers of the plurality of electronic devices are connected through a wire in the stereophonic sound system so that the cable layout becomes complicated and an installation distance is restricted.

Another object to be achieved by the present disclosure is to provide an audio device, an audio system, and a method which automatically synchronize outputs from speakers of a plurality of electronic devices, thereby solving the problems in that when a multi-channel audio signal is reproduced by combining wired/wireless speakers of a plurality of electronic devices, an audio output time difference occurs between speakers.

Another object to be achieved by the present disclosure is to provide an audio device, an audio system, and a method which automatically adjust the audio signal which is transmitted to the speakers per channel, thereby solving the problem in that a support of an expert is necessary to construct an audio environment which implements a stereophonic sound by providing a multi-channel audio signal to speakers of the plurality of electronic devices.

Another object to be achieved by the present disclosure is to provide an audio device, an audio system, and a method which automatically adjust a volume of the audio signal transmitted to the speakers per channel, thereby solving the problem in that when the wired/wireless speakers of the plurality of electronic devices are combined to reproduce a multi-channel audio signal, a level of an audio output is irregular due to the difference in a device performance and a specification of every speaker.

Technical objects to be achieved in the present invention are not limited to the aforementioned technical objects, and another not-mentioned technical object will be obviously understood by those skilled in the art from the description below.

According to an aspect of the present disclosure, a method of providing a multi-channel surround audio signal includes: searching for a plurality of electronic devices which is capable of receiving a multi-channel surround audio signal, designating two or more of electronic devices as a surround speaker sound channel, and synchronizing sounds of sound channels of the plurality of designated electronic devices.

Specifically, the method may further include: a searching step of searching for electronic devices which are capable of receiving a multi-channel surround audio signal; a transmitting step of generating a test audio signal and transmitting the test audio signal to the searched electronic devices; a feedback receiving step of receiving a signal of feedback audio output by the searched electronic devices from a microphone; an audio distance measuring/estimating step of measuring/estimating a distance between the searched electronic devices and the microphone based on an intensity of feedback audio signal, a step of designating two or more of the searched electronic devices based on the measured/estimated distance to configure a surround speaker sound channel, and a sound-per-channel synchronizing step of synchronizing an audio sound output by the plurality of electronic devices configured as the surround speaker sound channel.

According to another aspect of the present disclosure, an audio device which provides a multi-channel surround audio signal to speakers of a plurality of electronic devices includes: a mixing unit which adjusts a number of channels of an input audio signal based on a number of speakers connected to the audio device, a transmitting unit which transmits the audio signal with the adjusted number of channels or a test audio signal for setting a speaker to at least one of speakers of the plurality of electronic devices; a feedback receiving unit which receives a signal of an audio output from a microphone which collects audios output by at least one speaker of the speakers of the plurality of electronic devices; a surround speaker sound channel configuring unit which searches for electronic devices which are capable of receiving a multi-channel surround audio signal, transmits a test audio signal to the searched electronic devices through the transmitting unit, receives a feedback audio signal output by the searched electronic devices through the feedback receiving unit, measures/estimates a distance between the searched respective electronic devices and the microphone based on an intensity of the feedback signal, and designates two or more of the searched electronic devices as a surround speaker sound channel based on the measured/estimated distance; and a sound-per-channel synchronizing unit which synchronizes a sound of an audio sound channel output by the plurality of electronic devices configured as the surround speaker sound channel.

According to the exemplary embodiments, it is possible to provide an audio device, an audio system, and a method which construct a multi-channel audio system at a reduced cost which is different from the stereophonic sound system of the related art and maintain output synchronization between the speakers of the plurality of electronic devices.

According to the exemplary embodiments, an audio device, an audio system, and a method may construct a surround audio system by using speakers of electronic devices which may receive an audio signal, without purchasing a separate wireless speaker.

According to the exemplary embodiments, an audio device, an audio system, and a method may automatically adjust an audio signal for every channel to be suitable for a characteristic of each speaker, by supplying a feedback of an audio output by the speakers to an audio device which processes an audio signal.

Therefore, according to the exemplary embodiments, an audio device, an audio system, and a method easily implement a stereophonic sound system by utilizing existing speakers of electronic devices as wireless speakers without an additional cost for a speaker.

in an audio device, an audio system, and a method according to the exemplary embodiment of the present disclosure, a signal of an audio to be output is fed back to the audio processing device to determine an output delay time per channel so that even though the wired/wireless speakers are used together, the audio outputs per speaker may be synchronized.

Accordingly, in an audio device, an audio system, and a method according to the exemplary embodiment of the present disclosure, in addition to the wired speaker, speakers of the electronic devices are utilized as wireless speakers so that a stereophonic sound system which may minimize a cable layout and is free from the restriction in an installation distance may be implemented.

Further, in an audio device, an audio system, and a method according to the exemplary embodiment of the present disclosure, an output delay time per channel is automatically determined and the delay time is automatically compensated using the feedback of the audio signal output by the speakers so that it is possible to easily implement the stereophonic sound system without the help of experts.

Furthermore, an audio device, an audio system, and a method according to the exemplary embodiment of the present disclosure may generate a necessary compensation signal in accordance with the characteristic due to the difference of device performance and specification per speaker using a feedback of the audio signal output by the speakers to ensure a uniform level of outputs between speakers.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is an exemplary diagram of a surround speaker system of the related art;

FIG. 2 is an exemplary diagram of electronic devices which may be used in an exemplary embodiment of the present disclosure;

FIG. 3 is an exemplary diagram of an operating environment of an audio system which includes an audio device according to an exemplary embodiment of the present disclosure, a mobile terminal, electronic devices, and a network connecting them to provide a multi-channel surround audio signal;

FIG. 4 is an exemplary diagram of a surround speaker sound channel configuration which designates two or more of electronic devices as a surround speaker sound channel, according to an exemplary embodiment of the present disclosure;

FIG. 5 is an exemplary diagram of synchronizing a level of a sound volume through an AI speaker to configure a surround speaker system according to an exemplary embodiment of the present disclosure;

FIG. 6A is a flowchart of a surround speaker distance determining mode and a surround speaker sound channel configuring mode for synchronizing a sound volume;

FIG. 6B is a flowchart of configuring a surround speaker sound channel by estimating an audio distance of a surround speaker according to an exemplary embodiment of the present disclosure;

FIG. 6C is a flowchart of a surround audio distance determining mode to determine whether an electronic device is within a surround speaker configurable range;

FIG. 7 illustrates an internal block diagram of an audio device to provide a multi-channel audio signal to speakers of a plurality of electronic devices according to an exemplary embodiment of the present disclosure;

FIG. 8 is an exemplary diagram for explaining a feedback process of an audio signal output from an audio device according to an exemplary embodiment of the present disclosure;

FIG. 9 is a view for explaining a process of compensating a difference per channel based on an audio signal which is feedback to the audio device according to an exemplary embodiment of the present disclosure;

FIG. 10 is a view for explaining a method of determining a delay time by analyzing a test audio signal output from speakers according to an exemplary embodiment of the present disclosure;

FIG. 11 is a view for explaining a method of determining a delay time by analyzing a test audio signal output from speakers according to another exemplary embodiment of the present disclosure;

FIG. 12 illustrates a flowchart of a method of providing a multi-channel audio signal to speakers of a plurality of electronic devices according to an exemplary embodiment of the present disclosure;

FIG. 13 illustrates a flowchart for explaining an example that an audio is reproduced after setting the compensation per channel in accordance with a flowchart of FIG. 12;

FIG. 14 illustrates a flowchart of a method of providing a multi-channel audio signal having a volume level synchronized to speakers of a plurality of electronic devices according to another exemplary embodiment of the present disclosure;

FIG. 15 illustrates a flowchart for explaining an example that an audio is reproduced after setting the compensation per channel in accordance with a flowchart of FIG. 14;

FIG. 16 is a view for explaining a method of determining a volume difference per speaker in the flowchart of FIG. 14; and

FIG. 17 illustrates a flowchart of a method for setting compensation per channel in speakers of a plurality of electronic devices according to still another exemplary embodiment of the present disclosure.

### DETAILED DESCRIPTION

Hereinafter, the present disclosure will be described in more detail with reference to the drawings. As those skilled in the art would realize, the described embodiments may be modified in various different ways, all without departing from the spirit or scope of the present invention. Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

The shapes, sizes, ratios, angles, the number of elements given in the drawings are merely exemplary, and thus, the present disclosure is not limited to the illustrated details. Like reference numerals designate like elements throughout the specification.

In relation to describing the present disclosure, when the detailed description of the relevant known technology is determined to unnecessarily obscure the gist of the present disclosure, the detailed description may be omitted.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

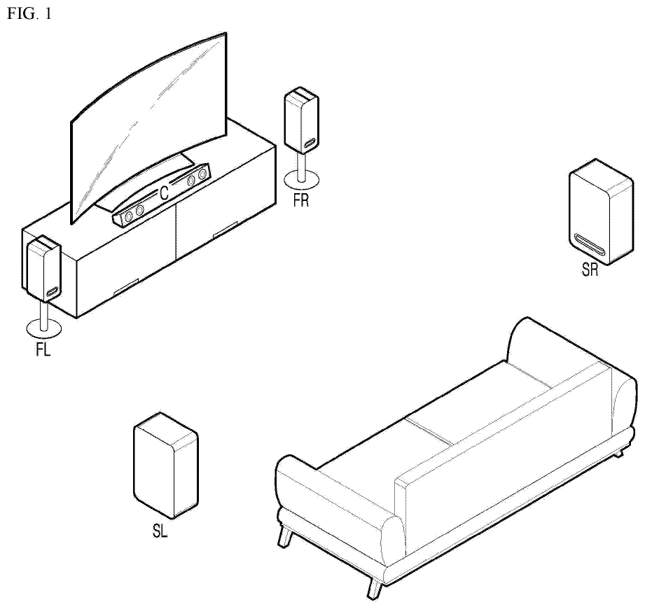

FIG. 1 is an exemplary diagram of a surround speaker system of the related art. FIG. 1 illustrates a speaker system configured by a center channel C, a front left channel FL, a front right channel FR, a surround left channel SL, and a surround right channel SR.

Surround sound (simply, surround) which stereoscopically outputs audio refers to a technique which enhances a recording quality of an audio source with an audio channel created through additional separate speakers. In the related art, a surround speaker system for the surround sound may be configured to be extended to 2.1 channel, 3.1 channel, 4.1 channel, or 5.1 channel with respect to a TV. According to the present disclosure, the surround speaker system is defined as all kinds of speaker systems formed by two or more speakers, among wired or wireless speakers.

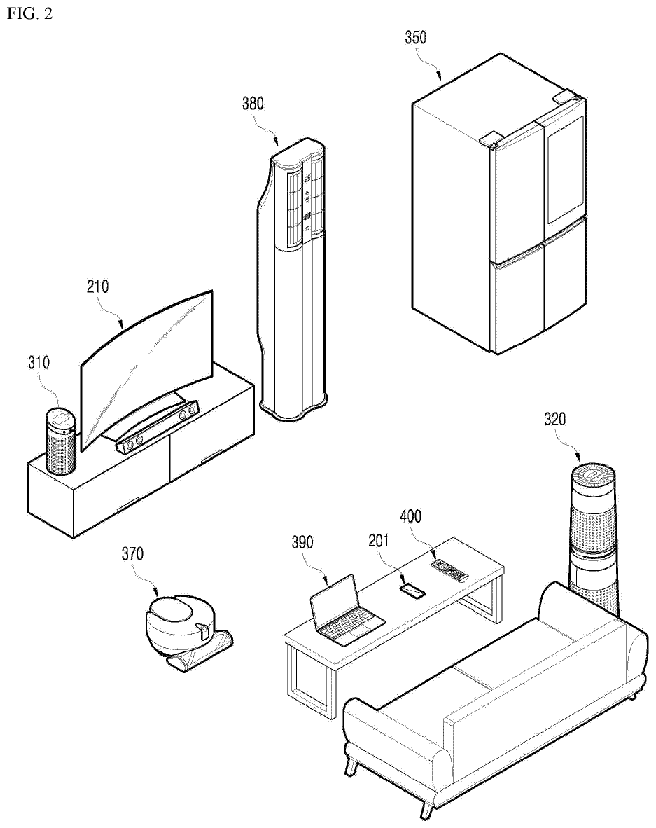

FIG. 2 is an exemplary diagram of electronic devices which may be used in an exemplary embodiment of the present disclosure. As it enters a 5G communication era, electronic devices which receive an audio signal are increased in addition to a Bluetooth speaker which wirelessly transmits sound. The electronic devices which are connected by the Internet of Things or mounted with artificial intelligence and include embedded microphones and speakers are increasing. There are various electronic devices which are configured as a surround speaker at home, such as a TV 210, an AI speaker 310, an air purifier 320, a refrigerator 350, a wall-mounted air conditioner 360, a robot cleaner 370, a stand-type air conditioner 380, and a notebook 390. If the electronic devices have speakers which receive an audio signal, a surround speaker system which outputs a surround sound may be configured without purchasing a separate speaker.

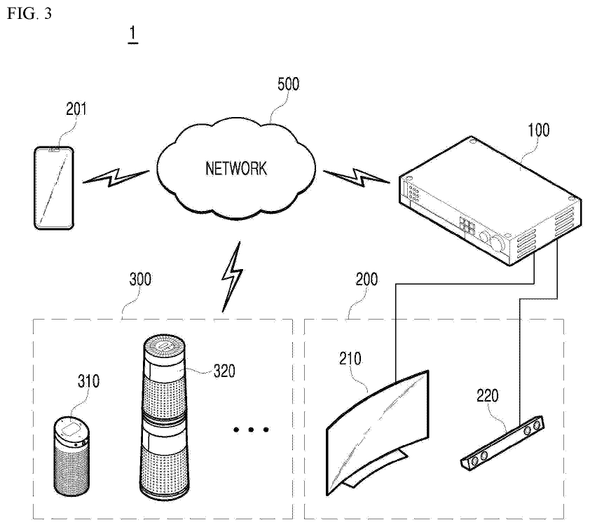

FIG. 3 is an exemplary diagram of an operating environment of an audio system which includes an audio device according to an exemplary embodiment of the present disclosure, a mobile terminal, electronic devices, and a network connecting them to provide a multi-channel surround audio signal. The audio device 100 may be connected to household electronic devices, such as the mobile terminal 201, the AI speaker 310, and the air purifier 320, through the network 500. The AI speaker 310 may be connected to the audio device 100 through a wire or wirelessly.

The audio device 100 may configure the surround system with a wired speaker 200 and a wireless speaker 300. Wired speakers 200 connected through a wire may include a center channel speaker 220 in the TV and the audio device 100. The wireless speakers 300 may include electronic devices such as the AI speaker 310, the air purifier 320, and the stand-type air conditioner 380 which wirelessly receive the audio signal from the audio device 100, in addition to a specialty speaker such as the Bluetooth speaker.

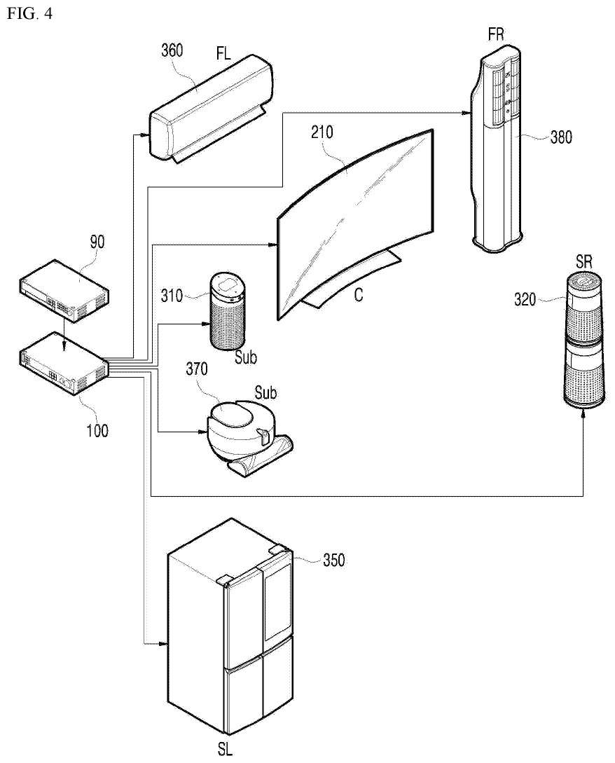

FIG. 4 is an exemplary diagram of a surround speaker sound channel configuration (5.2 channel) which designates two or more of electronic devices as a surround speaker sound channel, according to an exemplary embodiment of the present disclosure. Generally, the audio device 100 is connected to the TV 210 and a set top box 90 and is connected to a speaker channel 220, and further connected to additional speakers to generate a surround sound. The audio device 100 receives an audio signal from the set top box 90 or a DVD player or a DTV receiver which has a digital output to provide a surround sound. The audio device 100 may provide multi-channel digital decoding to wired and wireless speakers to provide a multi-channel surround sound. In the exemplary embodiment of FIG. 4, the TV configures a center channel C, the AI speaker 310 and the robot cleaner 370 configure subwoofers, the wall-mounted air conditioner configures a front left channel FL, the stand-type air conditioner 380 configures a front right channel FR, the refrigerator configures a surround left channel SL, and the air purifier 320 configures a surround right channel SR, respectively.

Even though the TV 210 is an image and audio reproducing device in the present disclosure, the TV includes the audio device 100 so that the TV itself may also serve as an audio device 100. According to the exemplary embodiment of the present disclosure, all kinds of devices which are capable of reproducing audio may be referred to as an audio device 100.

An image part of the audio device 100 reproduces an image through a display and an audio part processes an input audio signal to transmit the audio signal to the wired speaker 200 and the wireless speakers 310 and 320 (hereinafter, only the wireless speakers 310 and 320 are illustrated) to output the audio.

According to another exemplary embodiment of the present disclosure, the wired speaker 200 may be directly connected to the audio device 100 through a wire to receive an audio signal and output an audio signal of the front left channel and an audio signal of the front right channel among audio signals processed in the audio device 100. The wireless speakers 310 and 320 configured by the AI speaker and the air purifier may be formed as a surround left speaker 310 and a surround right speaker 320 and for example, receive and output an audio signal of a left rear channel and an audio signal of a right rear channel among audio signals processed in the audio device 100 connected by Bluetooth.

Here, the connection between the audio device 100 and the wireless speakers 310 and 320 may be formed by various methods such as Bluetooth, RFID, ultra wideband (UWB), infrared communication, Zigbee, digital living network alliance (DLNA), wireless LAN (WLAN), Wi-Fi direct, wireless broadband (Wibro), long term evolution/LTE-advanced (LTE/LTE-A), 5G, and Internet of things (IoT).

The audio device 100 searches for electronic devices which are capable of receiving multi-channel surround audio signals and designate two or more of the searched electronic devices as surround speaker sound channels to configure a surround speaker sound channel system.

According to another exemplary embodiment of the present disclosure, a remote controller 400 is a device which transmits a signal to the audio device 100 to control an operation of the audio device 100. The remote controller 400 may include a microphone to perform a function of collecting audio output by wired/wireless speakers.

When the audio signal is transmitted from the audio device 100 to the wired/wireless speakers 200, 310, and 320 and the audio is output by the wired/wireless speakers 200, 310, and 320, the remote controller 400 may collect the output audio through the microphone to feed the audio back to the audio device 100 again.

The remote controller 400 may be located in the middle of a listening space formed by the wired/wireless speakers 200, 310, and 320 to listen balanced sounds output by the speakers.

However, if a main listening position of the user is another place other than the middle of the listening space, the remote controller 400 is located in the main listening position of the user correspondingly to collect the audio output by the speakers.

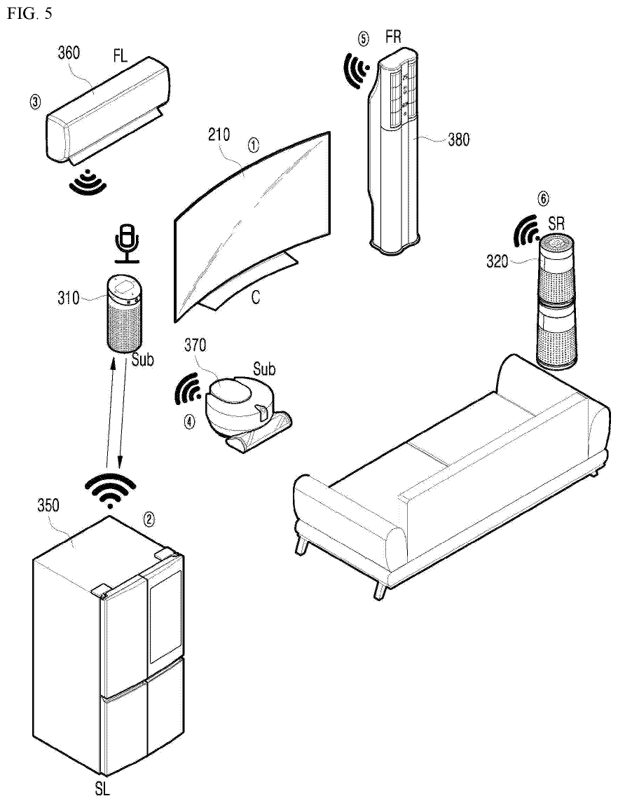

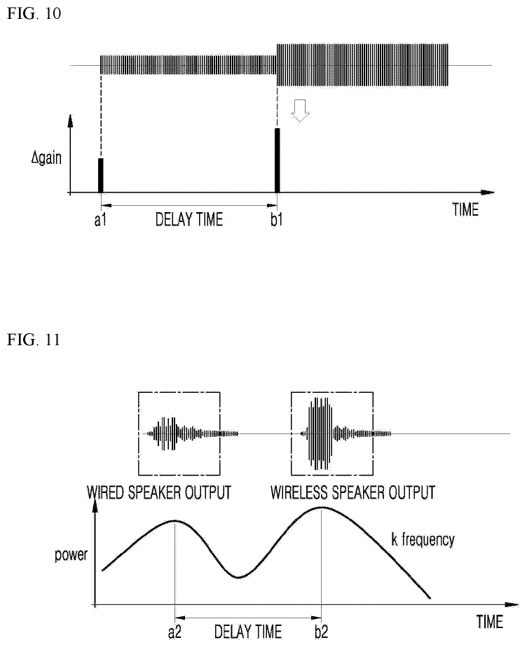

FIG. 5 is an exemplary diagram of synchronizing a level of a sound volume through an AI speaker to configure a surround speaker system according to an exemplary embodiment of the present disclosure. When the configuration of the surround speakers is completed, levels of sound volume are synchronized for the configured surround speakers. Since the AI speaker 310 is mounted with a plurality of microphones to sense sounds entering in the direction of 360 degrees, the performance superior to the microphone mounted in the audio device 100 may be obtained. The AI speaker may receive a feedback audio signal output from each electronic device, instead of a microphone in the audio device, in a surround speaker setting mode of FIGS. 12 to 14.

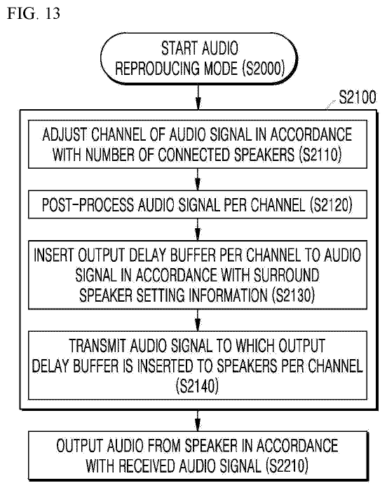

In order to receive the sound of each home appliance through a wire or wirelessly, the AI speaker 310 may sequentially receive the sounds of the home appliances 1 to 6 after activating the microphone to measure the level of the sound to synchronize the levels of the sounds of all electronic devices. When only the audio is reproduced, the audio device may configure the surround audio only with wireless speakers and synchronize the levels of the sounds for speakers of the electronic devices used as wireless speakers through the audio device or the AI speaker. A method of synchronizing a channel sound for wireless speakers will be described in detail with reference to FIGS. 12 and 14. When there is a speaker which is connected to the audio device through a wire, like TV, output time delay for simultaneous signals may occur between the wired speaker and the wireless speaker. Therefore, the audio device synchronizes an output delay time between the wired speaker and the wireless speaker through the microphone of the audio device and the microphone of the AI speaker first and then synchronizes the sound volume. The method of synchronizing an output delay time and synchronizing a sound volume for the wired/wireless speaker will be described with reference to FIGS. 12 and 14.

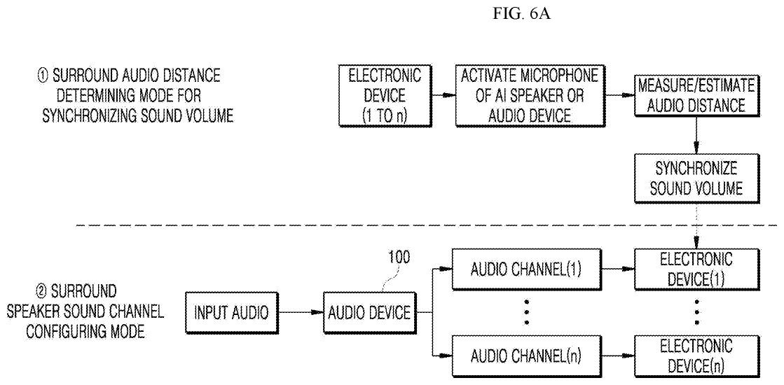

FIG. 6A is a flowchart of a surround speaker distance determining mode and a surround speaker sound channel configuring mode for synchronizing a sound volume.

In the surround speaker distance determining mode for synchronizing a sound volume, the audio device 100 may measure/estimate a distance between electronic devices serving as wireless speakers through the AI microphone or the microphone of the audio device and a microphone to configure a surround speaker sound channel or synchronize the level of the mode sound volume.

The audio device 100 may activate the AI speaker or the microphone in the audio device for the electronic devices 1 to n which are capable of receiving the audio signal, transmit an audio test signal for every electronic device to be synchronized, and collect a feedback audio signal output by the electronic device from the microphone to synchronize the level of the sound volume to be equal.

The electronic devices at home may include fixed electronic devices such as the wall-mounted air conditioner 360, the stand-type air conditioner 380, and the refrigerator 350 and movable electronic devices such as the air purifier 320 and the robot cleaner 370. Therefore, when the electronic devices are configured as the surround speaker sound channel, electronic devices serving as wireless speakers are movable so that the positions thoseof may be changed. Therefore, in order to determine whether the electronic devices which are configured as the surround speaker sound channel are within a surround speaker configurable range, the audio device 100 may measure/estimate the distance between the electronic devices serving as wireless speakers and the microphone.

The intensity of the sound is inversely proportional to the square of the distance from a sound source so that the audio device may measure/estimate the distance between the microphone and the electronic devices based on a waveform of a signal received from the microphone. In the case of a wave which is generated from one point to radially and uniformly spread, a space occupied by the wave is increased in proportion to the square of the distance as the distance is increased from a wave source. Therefore, the intensity of the wave is inversely proportional to the square of the distance as follows:

$$I = \frac{P}{A} = \frac{P}{4 π {R}^{2}}$$

Here, P is an energy emitted from a wave source per unit time and 47πR² is a surface area A of a sphere on which the wave energy is spread.

The audio device 100 may store surround speaker sound channel configuration information and volume level information per channel. The audio device 100 compares the surround speaker sound channel configuration information and the volume level information per channel which are previously stored with multi-channel surround speaker configuration information and volume level information per channel which are currently executed. When the surround speaker sound channel configuration information is equal, but the current volume level information per channel is different from the previous volume level information per channel (out of a critical tolerance range), the audio device determines that the distance is different from that of the previous position and notifies the user that the position of the electronic device which configures the surround audio sound channel is different from the previous position through the mobile terminal or the TV.

For example, when the air purifier 320 or the robot cleaner 370 are included in the surround speaker sound channel configuration information, but are disposed to be far from the TV, an intensity of the feedback audio signal output from the air purifier 320 or the robot cleaner 370 which is received for the same test audio signal is weak. It is possible to calculate or estimate that the distance is far by substituting the weak intensity of the audio signal into a formula in which the intensity is inversely proportional to the square of the distance of the sound wave. Therefore, the audio device may determine that the air purifier 320 or the robot cleaner 370 is out of the surround speaker configuration position. Further, as the comparison result with the volume level per channel which is previously stored, when the intensity of the signal output from the air purifier 320 or the robot cleaner 370 received for the same test audio signal is smaller than the intensify of the signal in accordance with the previous volume level, it is determined that the audio distance is farther and when the intensity of the signal output from the air purifier 320 or the robot cleaner 370 is larger than the intensity in accordance with the previous volume level, it is determined that the audio distance is closer so that the relative position may be determined. When the air purifier 320 or the robot cleaner 370 is out of the distance range which configures the surround speaker sound channel, the audio device may notify the user through the mobile terminal or the TV.

The electronic devices which configure the surround audio sound channel may reproduce the audio signal while performing its own function. Further, when a notice to the user is generated while performing its own function, the user may be notified through the mobile terminal or the TV and the audio signal is inactivated and the notice is output through its own speaker. Further, when each electronic device includes an embedded microphone, the function of the microphone may be turned off while receiving the audio signal.

FIG. 6B is a flowchart of configuring a surround speaker sound channel by estimating an audio distance of a surround speaker according to an exemplary embodiment of the present disclosure.

When a surround speaker sound channel configuring mode starts in step S800, the audio device 100 enters the surround speaker sound channel configuring mode in step S810.

The audio device 100 searches for electronic devices which are capable of receiving a surround audio signal in step S820. The electronic devices may be connected to each other by Bluetooth, WiFi, Internet of Things, home networking, or the like.

The audio device 100 generates a test audio signal and transmits the test audio signal to the searched electronic devices in step S830.

The audio device 100 receives a feedback of the signal of the output audio from the microphone which collects a feedback audio signal output by the searched electronic devices in step S840.

The audio device 100 estimates a distance between the searched electronic devices and the microphone based on an intensity of the feedback audio signal in step S850. It is possible to estimate whether to be in the surround speaker sound channel configuration range by an intensity of the signal with respect to the same test audio signal. When there is stored surround speaker sound channel configuration information, it is possible to estimate whether to be relatively closer or farther than the distance of the electronic device registered in the stored surround speaker sound channel configuration information with respect to the same test audio signal which is previously stored.

The audio device 100 determines a direction of the searched electronic devices in accordance with a position of a microphone which receives the strongest output feedback audio signal among microphones in the AI speaker which are radially installed in step S860. The AI speaker embeds six or more microphones in an orientation of 360 degrees to collect radial sound. Therefore, the audio device 100 sequentially transmits the test signal to the electronic devices and finds a position of a microphone which receives the strongest output feedback audio signal, among six or more microphones which receive the feedback signal, to find the position of the electronic device which feeds back the test signal.

The audio device 100 designates two or more of searched electronic devices as a surround speaker sound channel based on one or more of measured/estimated distance and the direction of the searched electronic devices to configure the surround speaker sound channel in step S870.

The audio device 100 stores the surround speaker sound channel configuration information in step S880 and ends the surround speaker sound channel configuring mode in step S890. The audio device 100 may store the surround speaker sound channel configuration information in a data storing unit so that the surround speaker sound channel configuration information which is previously stored may be loaded to be used.

FIG. 6C is a flowchart of a surround audio distance determining mode to determine whether an electronic device is within a surround speaker configurable range by measuring/estimating an audio distance of a surround speaker. The audio device 100 may enter the surround audio distance determining mode of a wireless speaker to equalize (synchronize a sound volume) output levels of the speakers before reproducing a multi-channel audio sound source by being connected to wired/wireless speakers 200 and 300 of a plurality of electronic devices in step S910. Only when the surround speaker sound channel configuration information which is previously stored is different from the electronic device which outputs a test signal, the surround audio distance determining mode may be performed.

The surround audio distance determining mode may start by the instruction of the user or automatically start when a speaker which is newly connected to the audio device 100 is sensed.

When the audio device 100 enters the surround audio distance determining mode in step S910, the audio device 100 transmits the signal to the searched electronic devices or an electronic device configured as a surround speaker sound channel registered in the stored surround speaker sound channel configuration information in step S920.

The audio device 100 receives a feedback of the signal of the audio output from the microphone which collects a feedback audio signal output by an electronic device to be tested in step S930.

The audio device 100 measures/estimates a distance between the plurality of electronic devices and the microphone based on an intensity of the feedback audio signal in step S940.

The audio device 100 determines whether the electronic device configured as a surround speaker is within the surround speaker configurable range, based on the measured/estimated distance in step S950.

If it is determined that the electronic device 100 configured as a surround speaker is not within the surround speaker configurable range, the audio device 100 notifies the user through the mobile terminal or the TV in step S960 and returns to the step S920 of transmitting the signal to the electronic device configured as a surround speaker sound channel registered in the stored surround speaker sound channel configuration information.

If it is determined that the electronic device configured as a surround speaker is within the surround speaker configurable range, the audio device stores the distance information between the plurality of electronic devices and the microphone in accordance with multi-channel surround speaker configuration information in step S970 and ends the surround audio distance determining mode in step S980.

The household electronic devices are limited at home and speakers of the electronic devices located at a fixed position such as the refrigerator 350, the wall-mounted air conditioner 360, and the stand-type air conditioner 380 are less likely to change the position from the surround speaker sound channel configuration information so that the speakers may be used as it is. Therefore, the surround audio distance determining mode may be performed only on movable electronic devices whose position is changed, such as the robot cleaner 370 and the air purifier 320.

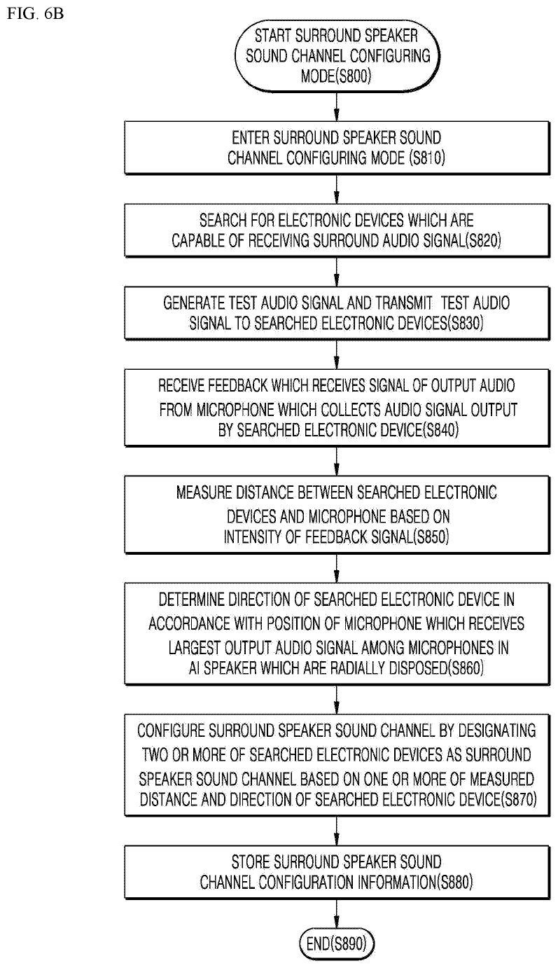

FIG. 7 illustrates an internal block diagram of an audio device to provide a multi-channel audio signal to speakers of a plurality of electronic devices according to an exemplary embodiment of the present disclosure.

The audio device 100 may include a controller 180, a surround speaker sound channel configuring unit 110, an audio obtaining unit 120, a mixing unit 130, a post-processing unit 140, and a transmitting unit 190. The transmitting unit 190 may be configured by a wired transmitting unit 150 which transmits an audio signal to the wired speaker 200 and a wireless transmitting unit 160 which transmits an audio signal to the wireless speaker 300.

In FIG. 3, two wired speakers 200 and the wireless speakers 310 and 320 are illustrated. However, for the convenience of description, the exemplary embodiment of the present disclosure will be described under the assumption that only one wired speaker 200 and one wireless speaker 300 are provided.

First, operations of components which are performed in the audio device 100 are performed through communication with the controller 180.

The surround speaker sound channel configuring unit 110 may search for electronic devices which are capable of receiving a multi-channel surround audio signal, transmit a test audio signal to the searched electronic devices through the transmitting units 150 and 160, receive a feedback audio signal output by the searched electronic devices through the feedback receiving unit 170, measure/estimate a distance between the searched electronic devices and the microphone based on the intensity of the feedback audio signal, and designate two or more of searched electronic devices as a surround speaker sound channel based on the measured/estimated distance.

The surround speaker sound channel configuring unit 110 autonomously may search for electronic devices which are capable of receiving multi-channel surround audio signals and designate two or more of searched electronic devices as surround speaker sound channels to configure a surround speaker sound channel system. Further, an APP installed in the mobile terminal 201 may search for electronic devices which are capable of receiving multi-channel surround audio signals, configure the surround speaker sound channel, and then transmit the surround speaker sound channel configuration information to the surround speaker sound channel configuring unit 110 of the audio device 100. According to an exemplary embodiment, the surround speaker sound channel configuration information may include that two or more of searched electronic devices are designated as one or more of a center channel C, a surround left channel SL, a surround right channel SR, a front left channel FL, a front right channel FR, and a subwoofer Sub.

Whenever a new configuration is provided, the surround speaker sound channel configuration information may be stored in the data storing unit of the audio device 100 and used to provide the multi-channel surround audio signal later based on the stored information. According to an exemplary embodiment, the step of searching for electronic devices which are capable of receiving an audio signal is omitted in accordance with the surround speaker sound channel configuration information which is previously stored and the test audio signal may be transmitted to the plurality of electronic devices which configure the stored multi-channel speaker.

The audio obtaining unit 120 obtains an audio signal from the outside in a real time or obtains an audio signal in a space stored in the audio device 100. The audio signal obtained from the audio obtaining unit 120 is transmitted to the mixing unit 130.

The mixing unit 130 performs a function of adjusting the number of channels of the input audio signal based on the number of speakers which are connected to the audio device 100. The number of speakers connected to the audio device 100 may be manually input to the audio device 100 in advance or the surround speaker sound channel configuration information may be input through the APP which is executed in the mobile terminal 201. Further, the audio device 100 may automatically obtain the number of speakers through the communication between the surround speaker sound channel configuring unit 110 of the audio device 100 and the speakers.

When the number of speakers connected to the audio device 100 is equal to the number of channels of input audio signal, the mixing unit 130 bypasses the input audio signal and when the number of speakers connected to the audio device 100 is different from the number of channels of input audio signal, the mixing unit 130 mixes up or down the input audio signal to adjust the number of channels of audio signal to be equal to the number of speakers connected to the audio device.

For example, when the audio signal input in the audio device 100 is two channels and the number of speakers connected to the audio device 100 are six as 5.1 channel speakers, the mixing unit 130 may mix up two-channel audio signal to be adjusted as a 5.1-channel audio signal.

As another example, when the audio signal input in the audio device 100 is 5.1 channel and the number of speakers connected to the audio device 100 is two, the mixing unit 130 may mix down 5.1-channel audio signal to be adjusted as a two-channel audio signal.

As another example, when the audio signal input in the audio device 100 is 5.1 channel and the number of speakers connected to the audio device 100 are six for 5.1 channel speakers, the mixing unit 130 may bypass the 5.1-channel audio signal without adjusting the 5.1 channel audio signal.

The audio signal which is adjusted or bypassed by the mixing unit 130 is transmitted to the post-processing unit 140. The post-processing unit 140 performs a processing operation required for an audio channel of each channel, which will be described in more detail below.

An audio signal of a channel to be output from the wired speaker among audio signals which are subjected to the processing such as application of a sound field effect in the post-processing unit 140 is transmitted to the wired transmitting unit 150 and an audio signal of a channel to be output from the wireless speaker is transmitted to the wireless transmitting unit 60. In some cases, the audio signal may be transmitted to only some of speakers, rather than all the speakers of the plurality of electronic devices.

The wired transmitting unit 150 transmits an audio signal of a corresponding channel to the wired speaker 200 through the wired connection and the wireless transmitting unit 160 may transmit an audio signal of a corresponding channel to the wireless speaker 300, for example, through the Bluetooth connection.

The transmitting unit 190 may not only transmit an audio signal to be generally reproduced to the speakers, but also transmit a test audio signal to the speakers when the audio device 100 enters a speaker setting mode to set the synchronization of the speakers.

In this case, the test audio signal may be a signal which is stored in advance in the audio device 100 or a signal which is received from the outside.

Here, the signal to the wired speaker 200 which is connected by a wire is immediately transmitted without causing delay unless there are special circumstances to be output through the wired speaker 200. However, in the wireless connection which may be affected by various environments, a time delay may be caused in the processing to signal transmission and audio output.

When the audio is output by the speaker which is an audio output device, an error which is caused by the delay of the output of the audio signal due to the audio system itself may be referred to as a system delay error.

The system delay error may include a delay generated during an audio signal transmitting process and a delay generated during a signal processing process of an audio output device due to the network environment.

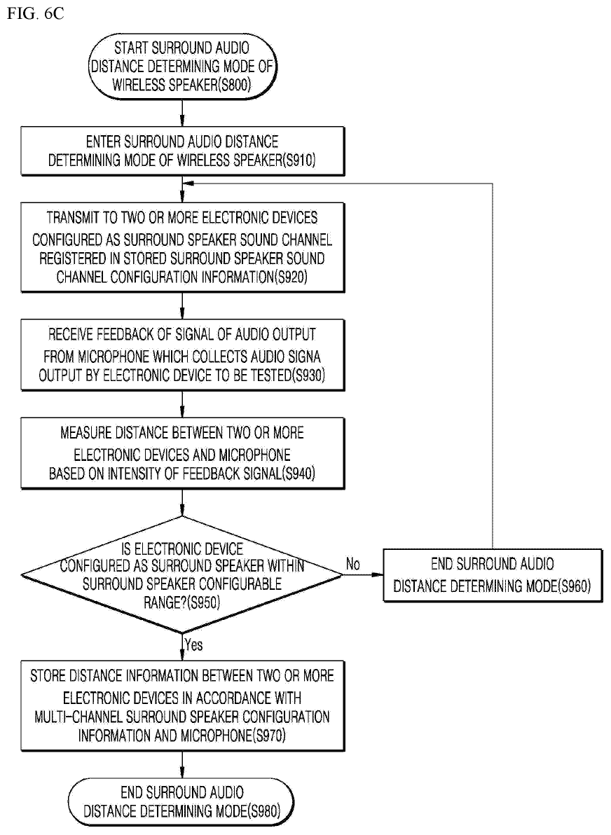

FIG. 8 is an exemplary diagram for explaining a feedback process of an audio signal output from an audio device according to an exemplary embodiment of the present disclosure.

As illustrated in FIG. 8, it is understood that a time delay of 400 msec is generated in the wireless speaker 300 as compared with the wired speaker 200 in the processing to the signal transmission and the audio output.

Therefore, an audio signal which needs to be simultaneously output from the wired speaker 200 and the wireless speaker 300 is output from the wired speaker 200 as a first audio output 230 first, and then is output from the wireless speaker 300 as a second audio signal 330 after 400 msec. Therefore, the multi-channel audio signal which needs to be simultaneously output is output with a time difference per channel.

As illustrated in FIG. 8, an audio output by the speakers is collected by an audio recording device 400 which includes a microphone 410 and a transmitting unit 430. The microphone 312 and the transmitting unit 314 of the AI speaker 310 may perform the same functions as the microphone 410 and the transmitting unit 430 of the audio recording device 400. An audio output 430 collected by the audio recording device 400 or the AI speaker 310 becomes an audio output in which a first audio output 230 and a second audio output 330 are combined.

The combined audio output 430 collected by the audio recording device 400 may be provided to the audio device 100 through a feedback loop 40. Here, the feedback loop 40 may be wired or wireless.

Further, even though it is illustrated that the audio recording device 400 is a separate device from the audio device 100 in FIG. 8, it is illustrated to separately represent the audio device 100 and the audio recording device 400 depending on the functions. The audio recording device 400 may be a remote controller including a microphone, but may be a microphone and a transmission module which are installed in the audio device 100 itself.

For example, the audio recording device 400 may be a microphone device which is attached to a TV which is the audio device 100.

As another example, the audio recording device 400 may be a remote controller 400 including a microphone as illustrated in FIG. 8. When the remote controller 400 which is movable at the outside is an audio recording device, a remote controller 400 is disposed in an actual position where the user listens to the sound of the speakers so that the user may collect more accurate output audio information.

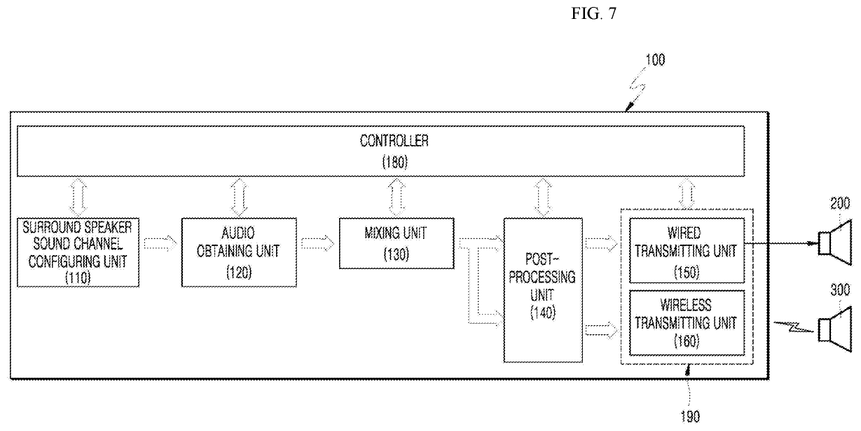

FIG. 9 is a view for explaining a process of compensating a difference per channel based on an audio signal which is fed back to the audio device according to an exemplary embodiment of the present disclosure.

The audio signal 430 which is output from the speakers of the plurality of electronic devices and fed back to the audio device 100 is received by the feedback receiving unit 170.

The feedback receiving unit 170 transmits the output audio signal to the controller 180 which includes a surround speaker audio distance determining unit 111, a difference-per-channel determining unit 113, and a compensation signal-per-channel generating unit 115. The surround speaker audio distance determining unit 111 of the controller 180 may measure/estimate a distance between the plurality of respective electronic devices and the microphone based on the intensity of the feedback audio signal from the feedback receiving unit 170 and determine whether the electronic device configured as the surround speaker is within a surround speaker configurable range. If the electronic device configured as the surround speaker is not within the surround speaker configurable range, the user is notified through the mobile terminal or the TV and if the electronic device configured as the surround speaker is within the surround speaker configurable range, the distance information between the plurality of respective electronic devices in accordance with the multi-channel surround speaker configuration information and the microphone may be stored. Further, the surround speaker audio distance determining unit 111 of the controller 180 may measure/estimate the distance between the electronic devices which perform the function as a wireless speaker and the microphone to determine whether the electronic device registered in the stored surround speaker sound channel configuration information is within the surround speaker configurable range.

Further, the surround speaker audio distance determining unit 111 of the controller 180 may receive surround speaker sound channel configuration information which designates two or more of electronic devices as a surround speaker sound channel from the APP of the mobile terminal 201 to transmit a test signal from the transmitting units 150 and 160, measure/estimate a distance between the plurality of electronic devices and the microphone based on the intensity of the feedback audio signal from the feedback receiving unit 170, and determine whether the electronic device configured as the surround speaker is within the surround speaker configurable range.

The difference-per-channel determining unit 113 of the controller 180 determines how much an output time difference between the speakers of the plurality of electronic devices exists, based on the audio signal which is fed back and output by the speakers.

It is determined how much an output time difference between the speakers of the plurality of electronic devices exists by various methods and some methods will be described herein as examples.

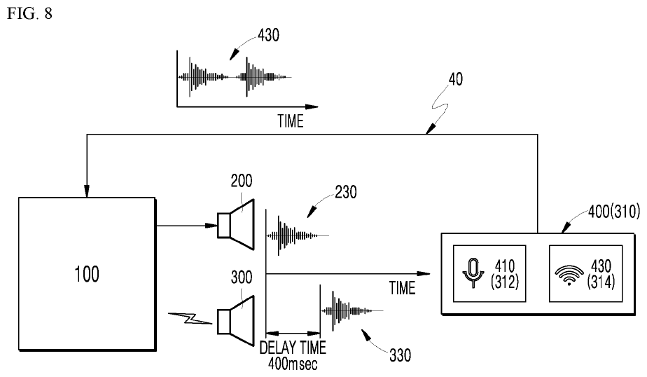

FIG. 10 is a view for explaining a method of determining a volume level and a delay time by analyzing a test audio signal output from speakers according to an exemplary embodiment of the present disclosure.

Referring to FIG. 10, the transmitting unit 190 transmits a first test audio signal to a first speaker (for example, the wired speaker 200) among the speakers of the plurality of electronic devices and transmits a second test audio signal to a second speaker (for example, the wireless speaker 300).

Here, the first test audio signal is a signal having a first volume, the second test audio signal is a signal having a second volume, and the first volume is lower than the second volume. The first test audio signal and the second test audio signal may be the same type of audio signal, but have different volumes.

According to another exemplary embodiment, a speaker setting mode may be configured such that the transmitting unit 190 of the audio device 100 transmits the same test audio signal to the speakers of the plurality of electronic devices and the first speaker (for example, the wired speaker 200) and the second speaker (for example, the wireless speaker 300) reproduce the test audio signal with different volumes.

In this case, when the first speaker outputs a test audio signal, for example, at a volume level 5 and the second speaker outputs the same test audio signal, for example, at a volume level 20, the microphone may collect a result obtained by combining audios having two different volumes.

Here, the volume of the speakers may be adjusted by a volume control signal which is transmitted from the audio device 100 or the remote controller 400 to the speakers in the speaker setting mode.

A waveform illustrated in an upper portion of FIG. 10 is formed by an audio output from the speakers which receive the first test audio signal and the second test audio signal or an audio output from the speakers in which the same test audio signal is set to have different volumes, which are collected by the microphone.

The waveform of FIG. 10 shows that the first test audio signal having a low first volume is output first at a timing a1 through the wired speaker 200 and the second test audio signal having a high second volume is output at a timing b1 which is later than the timing a1 due to the transmission delay to the wireless speaker and the processing delay in the wireless speaker, through the wireless speaker 300.

According to another exemplary embodiment in which the same test audio signal is transmitted to the speakers having different volumes, the waveform of FIG. 10 shows that the test audio signal is output first from the first speaker which is set to a low volume at the timing a1 and the same test audio signal is output from the second speaker which is set to a high volume at the timing b1 which is later than the timing a1. The delay may be caused by the transmission delay to the wireless speaker and the processing delay in the wireless speaker.

The feedback receiving unit 170 receives the waveform as illustrated in FIG. 10 as the audio signal output by the speaker and transmits the audio signal to the difference-per-channel determining unit 113.

The difference-per-channel determining unit 113 measures a time between a1 and b1 when a gain value is changed in the waveform as illustrated in FIG. 10 to determine that the output time difference between the wired speaker 200 and the wireless speaker 300 is a1 to b1 and a relative output delay time of the wireless speaker 300 to the wired speaker 200 is a1 to b1.

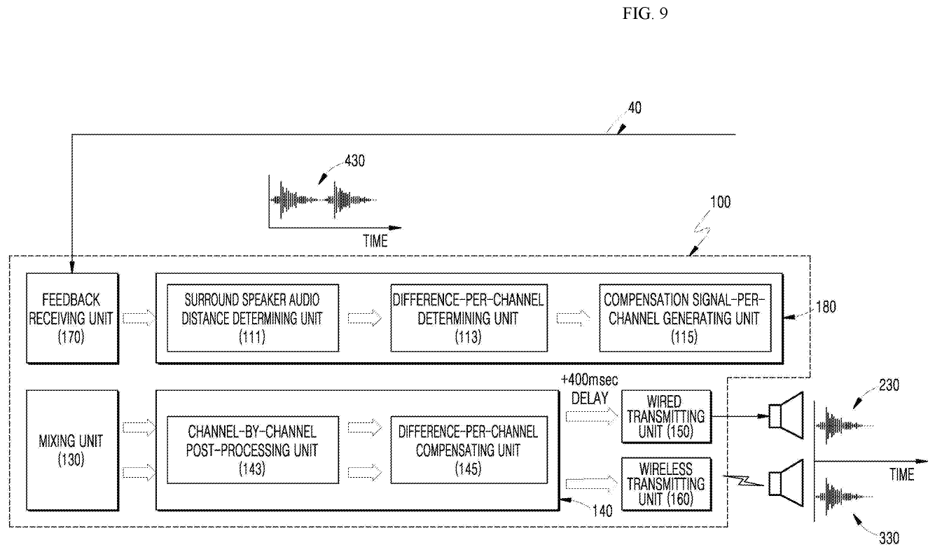

FIG. 11 is a view for explaining a method of determining a delay time by analyzing a test audio signal output from speakers according to another exemplary embodiment of the present disclosure.

Referring to FIG. 11, the transmitting unit 190 may simultaneously transmit the same test audio signal to the first speaker (for example, the wired speaker 200) and the second speaker (for example, the wireless speaker 300) among the speakers of the plurality of electronic devices.

Here, the test audio signal is a signal having a specific frequency pattern.

The waveform illustrated in an upper portion of FIG. 11 shows that the audio output from the speakers is collected by the microphone and the feedback audio signal output by the wired speaker 200 has a maximum value in the output at the timing a2 and the feedback audio signal output by the wireless speaker 300 has a maximum value in the output at the timing b2 which is later than a2, due to the transmission delay to the wireless speaker 300 and the processing delay in the wireless speaker 300.

The feedback receiving unit 170 receives the waveform as illustrated in FIG. 11 as the audio signal output by the speaker and transmits the audio signal to the difference-per-channel determining unit 113.

The difference-per-channel determining unit 113 may perform a fast Fourier transform (FFT) on the waveform as illustrated in FIG. 11 and measure a2 and b2 at which the maximum value of a specific frequency is generated to determine a relative delay time of the wireless speaker 300.

Here, according to the method of finding the delay time by the FFT, after sampling a test audio signal having a specific frequency pattern, how many samples among samples having the maximum value are different and the number of samples and a time per one sample are multiplied to calculate the delay time.

For example, when the test audio signal has a mono component of 2 bytes and 16 kHz and sampling is performed for every 256 samples with a value of 2 bytes, each sample has a time difference of 16 msec. To be more specific, in an audio signal in which 16000 2 bytes of data are transmitted per second, when one is sampled for every 256 2 bytes of data, a time x when 256 2 bytes of data are transmitted may be calculated by the equation of 1000 ms (one second): 16000=×msec: 256.

In this case, when the maximum value is obtained from a 20-th sample and a 30-th sample, the sample difference of two maximum values is 10 samples and the time difference is 16 msec per sample. Therefore, the delay time between the wired speaker 200 and the wireless speaker 300 figured out by the test audio signal is determined as 160 msec.

That is, when the waveform as illustrated in FIG. 11 is fed back to the audio device 100 through the microphone 410, the difference-per-channel determining unit 113 may determine that the output time difference between the wired speaker 200 and the wireless speaker 300 is a2 to b2 and the relative output delay time of the wireless speaker 300 to the wired speaker 200 is a2 to b2.

In the meantime, even though not illustrated in the drawings, the delay time of the speaker connected to the TV may be determined using a round-trip latency which is mainly used to determine an output delay with respect to the input of a smart phone.

The round-trip latency of the TV speaker is measured by measuring the delay time between the input and the output generated by repeatedly perform the operations of outputting a test signal from the speaker of the TV, receiving the output test signal to the microphone which communicates with the TV, outputting the input test signal to the speaker of the TV again, and receiving the output test signal to the microphone again, and outputting the input test signal to the speaker of the TV.

Similarly to the above-described method, the audio device 100 according to the exemplary embodiment of the present disclosure repeatedly performs the operations of transmitting the test audio signal to the wireless speaker 300 to output the test audio signal through the wireless speaker 300, collecting the output audio through the microphone 410 to transmit the output audio to the audio device 100, and transmitting the received signal of the output audio to the wireless speaker 300 to output the audio signal through the wireless speaker 300 a predetermined number of times.

The delay generated between the input through the microphone 410 and the output through the wireless speaker 300 is measured by the repeated operation to determine the round-trip latency for the wireless speaker 300.

Here, the difference-per-channel determining unit 113 may determine an output time difference between the wired speaker 200 and the wireless speaker 300 based on the round-trip latency for the wireless speaker 300 and the data on the output delay time of the wired speaker 200 which is stored in advance.

The data on the output delay time of the wired speaker 200 may be measured in advance to be stored in the data storing unit of the audio device 100.

The audio device 100 may learn a delay time characteristic for every speaker model by various methods as described above and store the delay time characteristic in an internal storage space of the audio device 100 or a storage space of a cloud to construct a delay time database for every speaker model.

When the database is constructed, the audio device 100 may not perform the above-described delay time measuring method, but simply check just the model information of the speaker to determine the delay time and set a time delay buffer appropriate for an output channel route to compensate the corresponding delay time.

Even though in the above description, it is assumed that only two speakers are connected, it is obvious that the same method may be applied to a plurality of speakers.

According to the above-described method, when an output time difference between two speakers is already known and a new speaker is connected to the audio device 100, a delay time for the new device is measured and then a deviation from the delay time of the existing speakers may be calculated to select a delay time value set for each speaker.

If the connected speaker is the same model product as the speaker from which the delay time is previously measured, data of the existing same model speaker may be utilized without additionally measuring the delay time.

Referring to FIG. 9 again, the difference-per-channel determining unit 113 determines the output time difference between speakers by various methods as described above and transmits the information on the time difference to the compensation signal-per-channel generating unit 115. The compensation signal-per-channel generating unit 115 may generate a compensation signal which compensates an output time difference between speakers to transmit the compensation signal to a difference-per-channel compensating unit 145 of the post-processing unit 140.

The post-processing unit 140 receives a multi-channel audio signal from the mixing unit 130 to perform the post-processing required for every channel such as addition of sound field effect, through a channel-by-channel post-processing unit 143 and transmits an audio signal per channel to the difference-per-channel compensating unit 145.

The difference-per-channel compensating unit 145 additionally sets an output delay signal to compensate the delay time per channel in accordance with the compensation signal received from the controller 180.

For example, as illustrated in FIG. 8, when the wireless speaker 300 has an output delay time of 400 msec as compared with the wired speaker 200, the difference-per-channel compensating unit 145 additionally sets an output delay signal of 400 msec to an audio signal of a channel which is output to the wired speaker 200.

Therefore, the audio signal of the channel which is output to the wired speaker through the wired transmitting unit 150 is delayed by 400 msec and is synchronized with an audio signal of a channel output through the wireless speaker 300 which has a delay of 400 msec due to the device characteristic.

FIG. 12 illustrates a flowchart of a method of providing a multi-channel audio signal to speakers of a plurality of electronic devices according to an exemplary embodiment of the present disclosure.

The audio device 100 may enter a speaker setting mode to synchronize the output times of the speakers and equalize (synchronize the sound volume) output levels of the speakers before reproducing a multi-channel audio sound source after being connected to speakers 200 and 300 of the plurality of electronic devices in step S1110.

The speaker setting mode may start by the instruction of the user or automatically start when a speaker which is newly connected to the audio device 100 is sensed.

When the audio device 100 enters the speaker setting mode in step S1110, the audio device 100 generates a test audio signal first in step S1120. The test audio signal may be transmitted to speakers to be tested in step S1130. All the steps S1100 may be performed by the audio device 100.

Here, the test audio signal may be one same test audio signal or test audio signals having different volumes for every speaker, as described above, depending on the aspect of the present disclosure.

The speakers which receive the test audio signal may output a test audio in step S1210 and the microphone 400 may collect the output audio in step S1220. The collected output audio signal may be fed back to the audio device by the transmitting unit 430 which is connected to the microphone 410 in step S1230.

The audio device 100 may receive and analyze the fed-back output audio signal by the above-described methods to calculate an output time difference between the speakers and a relative delay time in step S1310.

The compensation signal is generated based on the calculated delay time in step S1320, an output delay buffer is set in the audio channel route to synchronize the outputs of the speakers based on the compensation signal, and the setting is stored in the data storing unit of the audio device 100 in step S1330.

For example, as illustrated in FIGS. 8 and 9, in order to synchronize the output between the wired speaker 200 and the wireless speaker 300, an output delay buffer of 400 msec may be set in the channel route of the audio signal to be output to the wired speaker 200.

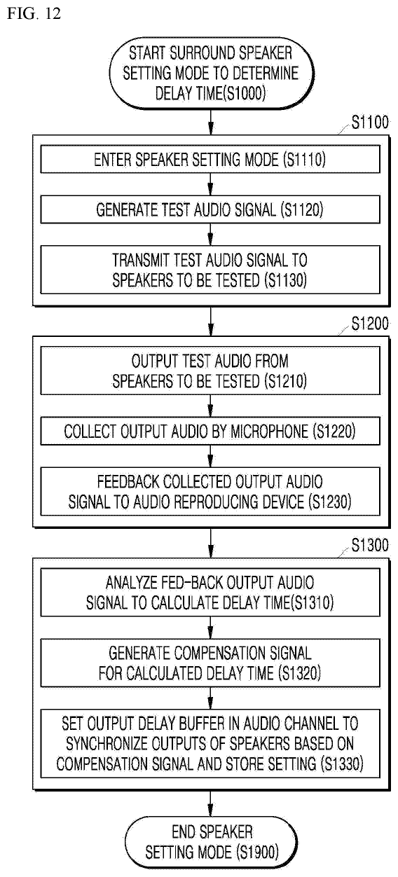

FIG. 13 illustrates a flowchart when all the speaker setting mode as described above ends in step S1900 and a general audio reproducing mode starts.

When an audio signal to be reproduced is input to the audio device 100 from the outside, a channel of the input audio signal is adjusted in accordance with the number of speakers connected to the audio device 100 in step S2110. A post-processing required for every channel, such as addition of a sound field effect is performed on the audio signal with an adjusted channel in step S2120 and an output delay buffer may be inserted to the audio signal per channel, as stored in the speaker setting mode as described above in step S2130.

As illustrated in FIGS. 8 and 9, in order to synchronize the output between the wired speaker 200 and the wireless speaker 300, an output delay buffer of 400 msec may be inserted to the audio signal of a channel to be output to the wired speaker 200.

The audio signal into which the output delay buffer is inserted is transmitted to the speakers and the speakers output the audio in accordance with the received audio signal in step S2210.

The output delay buffer for every channel is inserted as described above so that the wired speaker 200 and the wireless speaker 300 may output a synchronized audio.

FIG. 14 illustrates a flowchart of a method of providing a multi-channel audio signal to speakers of a plurality of electronic devices to synchronize a sound volume according to another exemplary embodiment of the present disclosure.

The audio device 100 may enter a speaker setting mode to synchronize the output times of the speakers first and equalize (synchronize the sound volume) output levels of the speakers before reproducing a multi-channel audio sound source after being connected to wired/wireless speakers 200 and 300 of the plurality of electronic devices in step S3110. In contrast, according to another exemplary embodiment of the present disclosure, when only the wireless speakers 310 and 320 configure the surround speaker, as output levels of the speakers are equalized (synchronize the sound volume) and output times of the speakers are synchronized, the order of output time synchronization and sound volume synchronization may be changed.

The speaker setting mode may start by the instruction of the user or automatically start when a speaker which is newly connected to the audio device 100 is sensed.

When the audio device 100 enters the speaker setting mode in step S3110, the audio device 100 generates a test audio signal first in step S3120. The test audio signal may be transmitted to speakers to be tested in step S3130. All the steps S3100 may be performed by the audio device 100.

The step of transmitting the test audio signal may be a step of transmitting a test audio signal to the wired speaker 200 first among speakers of the plurality of electronic devices and transmitting the same test audio signal to the wireless speaker 300 after the first time.

Here, the first time may be selected in advance as a time difference in which the audio output from the speakers do not completely overlap and a difference between volumes output from the speakers can be observed.

The speakers which receive the test audio signal may output a test audio in step S3210 and the microphone 400 may collect the output audio in step S3220. The collected output audio signal may be fed back to the audio device 100 by the transmitting unit 430 which is connected to the microphone 410 in step S3230.

The audio device 100 may receive and analyze the fed-back output audio signal to calculate an output volume for every speaker and calculate an output difference between the speakers in step S3310.

To determine an output difference per channel or every speaker is to determine a volume output difference between the wired speaker 200 and the wireless speaker 300 based on a difference between an average volume of an initial audio signal in the signal of the output test audio and an average volumes of a latter audio signal existing after the first time from a starting time of the initial audio signal.

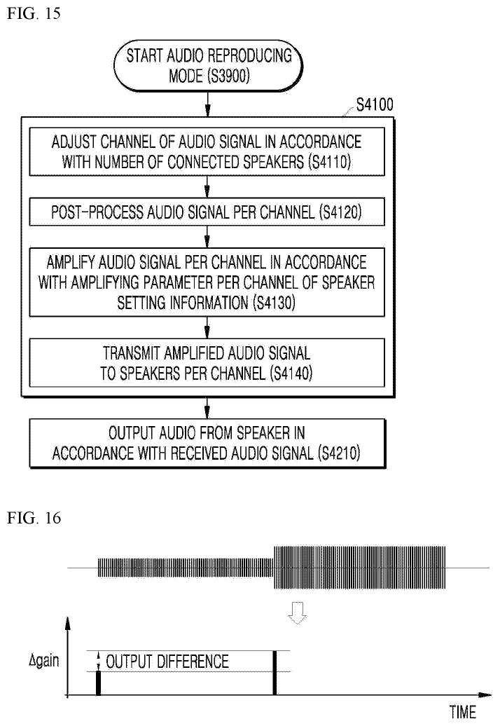

Here, the initial audio signal and the latter audio signal may refer to signals before and after the point when the difference of the volume value is generated, as illustrated in FIG. 16.

The compensation signal is generated for the calculated volume difference per speaker in step S3320 and an amplifying or attenuating parameter for every channel may be set such that the output volumes of the speakers become the same level based on the compensation signal and the setting may be stored in the data storing unit.

For example, even though the signal having the same volume is transmitted as illustrated in FIG. 16, when an output volume of the wired speaker 200 seen from the initial audio signal is smaller than an output volume of the wireless speaker 300 seen from the latter audio signal, the amplifying parameter may be applied to the channel route of the audio signal to be output to the wired speaker 200 to equalize (synchronize the sound volume) the output volumes between speakers.

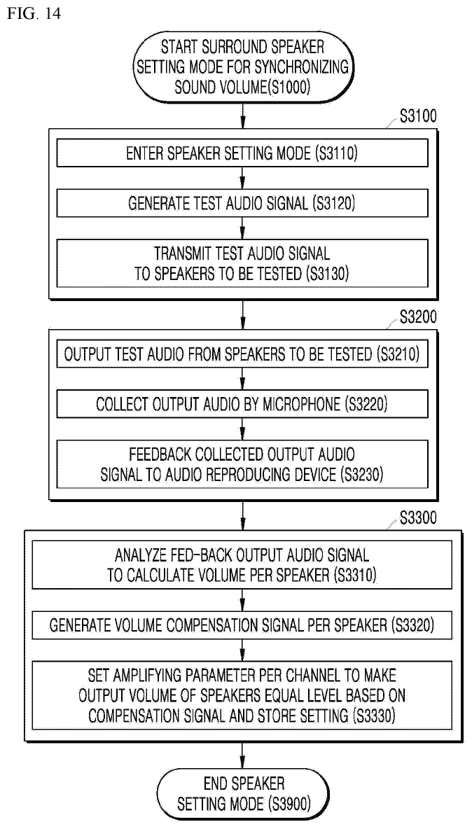

FIG. 15 illustrates a flowchart when all the speaker setting mode as described above ends in step S3900 and a general audio reproducing mode starts.

When an audio signal to be reproduced is input to the audio device 100, a channel of the input audio signal is adjusted in accordance with the number of speakers connected to the audio device 100 in step S4110. A post-processing required for every channel, such as addition of a sound field effect is performed on the audio signal with an adjusted channel in step S4120 and an amplifying parameter or an attenuating parameter may be applied to the audio signal for every channel, as stored in the speaker setting mode in step S4130.

That is, an output of an audio signal of a channel which is provided to a speaker having a low volume output among the wired or wireless speakers, among the multi-channel audio signals, is amplified or an output of an audio signal of a channel which is provided to a speaker having a high volume output among the wired or wireless speakers, among the multi-channel audio signals, is attenuated to equalize the outputs of the wired/wireless speakers.

FIG. 16 is a view for explaining a method of determining a volume difference per speaker in the flowchart of FIG. 14.

Even though the same test audio signal is transmitted to the wired speaker 200 and the wireless speaker 300, as illustrated in FIG. 16, a volume of an audio output from the wired speaker 200 and a volume of an audio output from the wireless speaker 300 are different from each other.

This is because the wireless speaker 300 is set to output an audio with a larger volume than the wired speaker 200 in accordance with the device characteristic.

Therefore, the output of an audio signal of a channel which is transmitted to the wired speaker 200 is amplified or an output of an audio signal of a channel which is transmitted to the wireless speaker 300 is attenuated based on the difference between output volumes figured out from the waveform of FIG. 16.

Therefore, an audio signal which is more amplified is transmitted to the speaker having a low basic output volume and an audio signal which is more attenuated is transmitted to a speaker having a high basic output volume so that the output levels between the speakers may be automatically balanced.

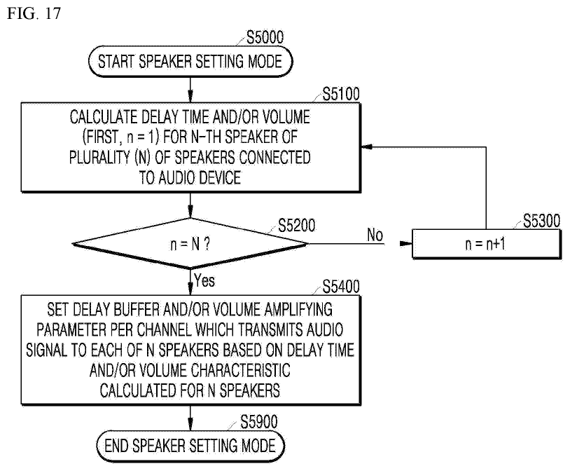

FIG. 17 illustrates a flowchart of a method for setting compensation per channel in speakers of a plurality of electronic devices according to another exemplary embodiment of the present disclosure.

In FIG. 17, it is assumed that a plurality (for example, N) of speakers is connected to the audio device.

The audio device 100 to which a plurality of speakers is connected receives a speaker setting mode command from the outside or the audio device 100 detects new speaker connection to automatically start a speaker setting mode in step S5000.

In the speaker setting mode, first, at least one of a delay time or a volume of the first speaker may be calculated in accordance with the method described in FIG. 12 or 14. The audio device 100 may interwork with the first speaker to temporarily store at least one of a delay time value or a volume characteristic value of the first speaker derived by the performed calculation.

The audio device 100 may determine whether the delay time and/or volume of all connected speakers is calculated in step S5200. The determination may be performed by various methods and for example, arbitrarily stored data and information on speakers connected to the audio device 100 are compared to perform the determination.

When it is determined that the delay time and/or volume are not calculated for all the speakers in step S5200, the delay time and/or volume of a next speaker may be calculated by returning to step S5100.

When it is determined that the delay time and/or volume are calculated for all the speakers in step S5200, a delay buffer and/or volume amplifying parameter may be set for every channel which transmits an audio signal to N speakers based on the delay time and/or volume characteristic calculated for N speakers.

Here, the delay buffer may be set to simultaneously reproduce the audio signal which is transmitted for every channel from the speakers and the volume amplifying parameter may be set to reproduce the audio signal which is transmitted for every channel from each speaker at the same level.

Although a specific embodiment of the present invention has been described and illustrated above, the present invention is not limited to the described embodiment and it is understood by those skilled in the art that the present invention may be modified and changed in various specific embodiments without departing from the spirit and the scope of the present invention. Therefore, the scope of the present invention is not determined by the described embodiment, but may be determined by the technical spirit described in the claims.

What is claimed is:

1. A method for providing a multi-channel surround audio signal to a plurality of electronic devices including speakers, performed by an audio device, the method comprising:
searching for electronic devices which are capable of receiving a multi-channel surround audio signal;
transmitting a test audio signal to the searched electronic devices;
receiving a feedback audio signal which is output by the searched electronic devices from a microphone;
estimating a distance between the searched electronic devices and the microphone based on an intensity of the feedback audio signal;
designating and configuring two or more of the searched electronic devices as a surround speaker sound channel based on the estimated distance; and
synchronizing an audio sound output by the plurality of electronic devices configured as the surround speaker sound channel for every channel.

2. A method for providing a multi-channel surround audio signal to a plurality of electronic devices including speakers, performed by one or more of an audio device and a mobile terminal, the method comprising:
searching for electronic devices which are capable of receiving a multi-channel surround audio signal, by the mobile terminal;
displaying the searched electronic devices by the mobile terminal so as to allow a user to designate two or more of the searched electronic devices as a surround speaker sound channel to configure the surround speaker sound channel;
transmitting the surround speaker sound channel configuration to the audio device by the mobile terminal;
transmitting a test audio signal to electronic devices registered in the surround speaker sound channel configuration;
receiving a feedback audio signal which is output by the registered electronic devices from a microphone; and
synchronizing an audio sound output by the plurality of electronic devices configured as the surround speaker sound channel for every channel, by the audio device.

3. The method for providing a multi-channel surround audio signal according to claim 1, wherein the configuring of a surround speaker sound channel includes: designating two or more of the searched electronic devices as one or more of a center channel C, a surround left channel SL, a surround right channel SR, a front left channel FL, a front right channel FR, and a subwoofer Sub.

4. The method for providing a multi-channel surround audio signal according to claim 1, wherein one of the plurality of electronic devices is an AI speaker and the receiving of the output feedback audio signal includes receiving the output feedback audio signal from a microphone of the AI speaker.

5. The method for providing a multi-channel surround audio signal according to claim 1, further comprising:
storing surround speaker sound channel configuration information;
performing the transmitting of the test audio signal to the electronic device registered in the stored surround speaker sound channel configuration information, the receiving of the feedback audio signal, and the estimating of the distance; and
notifying a user through a mobile terminal or a TV when the registered electronic device is not within a surround speaker configurable range.

6. The method for providing a multi-channel surround audio signal according to claim 1, wherein the synchronizing of a sound for every channel includes:
determining an output time difference between speakers of the plurality of electronic devices for every channel based on a signal of the output audio; and
compensating a difference per channel by setting an output delay buffer to at least one channel route among multi-channel routes of an audio signal which is provided to the speakers of the plurality of electronic devices to synchronize the outputs of the speakers of the plurality of electronic devices, based on the determined output time difference.

7. The method for providing a multi-channel surround audio signal according to claim 6, wherein in the transmitting of a test audio signal, the same test audio signal is transmitted to a first speaker and a second speaker among the speakers of the plurality of electronic devices and the test audio signal is a signal having a specific frequency pattern,
in the receiving of a feedback audio signal, the output test audio signal is received from a microphone which collects the test audio output by the first speaker and the second speaker, and
in the determining of the time difference per channel, a part of the output test audio signal in which a signal intensity of the specific frequency has a maximum value is measured to determine an output time difference between the first speaker and the second speaker.

8. The method for providing a multi-channel surround audio signal according to claim 6, wherein in the transmitting of a test audio signal, a first test audio signal is transmitted to a first speaker among the speakers of the plurality of electronic devices and a second test audio signal is transmitted to a second speaker among the speakers of the plurality of electronic devices,
the first test audio signal is a signal having a first volume, the second test audio signal is a signal having a second volume, and the first volume and the second volume have different levels,
in the receiving of the feedback audio signal, a signal of the output test audio is received from a microphone which collects the test audio output by the first speaker and the second speaker, and
in the determining of the time difference per channel, a part of the signal of the output test audio in which a gain value is changed is measured to determine an output time difference between the first speaker and the second speaker.

9. The method for providing a multi-channel surround audio signal according to claim 7, wherein in the compensating of a difference per channel, an output delay buffer is set to a channel route which is provided to a speaker in which the output is less delayed, between the first and second speakers, among the multi-channel audio signals to synchronize the outputs of the first and second speakers, based on the determined output time difference between the first speaker and the second speaker.

10. The method for providing a multi-channel surround audio signal according to claim 7, wherein in the transmitting of a test audio signal, the same test audio signal is transmitted to the first speaker and the second speaker among the speakers of two or more electronic devices with a difference of a first time,
in the receiving of the feedback audio signal, a signal of the output test audio is received from a microphone which collects the test audio output by the first speaker and the second speaker, and
in the determining of the time difference per channel, a volume output difference between the first speaker and the second speaker is determined based on a difference between an average volume of an initial audio signal and an average volume of a latter audio signal existing after the first time from a starting point of the initial audio signal in the signal of the output test audio.

11. The method for providing a multi-channel surround audio signal according to claim 10, wherein the compensating of a difference per channel further includes amplifying an output of an audio signal of a channel which is provided to a speaker having a low volume output between the first and the second speakers among the multi-channel audio signals or attenuating an output of an audio signal of a channel which is provided to a speaker having a high volume output between the first and second speakers among the multi-channel audio signals to equalize the outputs of the first and second speakers, based on the determined volume output difference between the first speaker and the second speaker.

12. The method for providing a multi-channel surround audio signal according to claim 7, further comprising:
after the compensating of a difference per channel,
inputting an audio signal by the audio device; and
mixing a number of channels of the input audio signal based on a number of speakers connected to the audio device,
wherein in the mixing, when the number of speakers connected to the audio device is equal to the number of channels of the input audio signal, the input audio signal is bypassed and when the number of speakers connected to the audio device is different from the number of channels of the input audio signal, the input audio signal is mixed up or down to adjust the number of channels of the audio signal to be equal to the number of speakers connected to the audio device.

13. An audio device which provides a multi-channel surround audio signal to a plurality of electronic devices including speakers, the audio device comprising:
a mixing unit which adjusts a number of channels of the input audio signal based on a number of speakers connected to the audio device,
a transmitting unit which transmits the audio signal with the adjusted number of channels or a test audio signal for setting a speaker to at least one of speakers of the plurality of electronic devices;
a feedback receiving unit which receives a signal of the output feedback audio from the microphone which collects the output feedback audio by at least one speaker of the speakers of the plurality of electronic devices;
a surround speaker sound channel configuring unit which searches for electronic devices which are capable of receiving the multi-channel surround audio signal, transmits the test audio signal to the searched electronic devices through the transmitting unit, receives a feedback audio signal output by the searched electronic devices through the feedback receiving unit, estimates a distance between the searched electronic devices and the microphone based on an intensity of the feedback audio signal, and designates two or more of the searched electronic devices as a surround speaker sound channel based on the estimated distance; and
a sound-per-channel synchronizing unit which synchronizes a sound of an audio sound channel output by the plurality of electronic devices configured as the surround speaker sound channel.

14. The audio device according to claim 13, wherein the surround speaker sound channel configuring unit receives surround speaker sound channel setting information in which two or more of the searched electronic devices are designated as a surround speaker sound channel from an APP performed in a mobile terminal.

15. The audio device according to claim 13, wherein one of the plurality of electronic devices is an AI speaker and the feedback receiving unit receives the output feedback audio signal from a microphone of the AI speaker.

16. The audio device according to claim 13, wherein the sound-per-channel synchronizing unit includes:
a difference-per-channel determining unit which determines an output time difference between the speakers of the plurality of electronic devices based on the signal of the output feedback audio; and
a difference-per-channel compensating unit which adds an output delay signal to at least one channel audio signal among multi-channel audio signals which are provided to the speakers of the plurality of electronic devices to synchronize the outputs of the speakers of the plurality of electronic devices, based on the determined output time difference.

17. The audio device according to claim 13, wherein in a speaker setting mode of the audio device, the transmitting unit is configured to transmit the same test audio signal to a first speaker and a second speaker among speakers of the plurality of electronic devices with a difference of a first time;
the feedback receiving unit is configured to receive a signal of the output test audio from the microphone which collects the test audio output by the first speaker and the second speaker, and
the difference-per-channel determining unit is further configured to determine a volume output difference between the first speaker and the second speaker based on a difference between an average volume of an initial audio signal and an average volume of a latter audio signal existing after the first time from a starting point of the initial audio signal in the signal of the output test audio.

18. The audio device according to claim 17, wherein the difference-per-channel determining unit is further configured to amplify an output of an audio signal of a channel which is provided to a speaker having a low volume output between the first and the second speakers among the multi-channel audio signals or attenuate an output of an audio signal of a channel which is provided to a speaker having a high volume output between the first and second speakers among the multi-channel audio signals to equalize the outputs of the first and second speakers, based on the determined volume output difference between the first speaker and the second speaker.

19. The audio device according to claim 16, wherein the difference-per-channel compensating unit is further configured to amplify an output of an audio signal of a channel which is provided to a speaker having a low volume output between the first and the second speakers among the multi-channel audio signals or attenuate an output of an audio signal of a channel which is provided to a speaker having a high volume output between the first and second speakers among the multi-channel audio signals to equalize the outputs of the first and second speakers, based on the determined volume output difference between the first speaker and the second speaker.
